(19) United States
(12) Patent Application Publication
(10) Pub. No.: US 2026/0012814 A1
(43) Pub. Date: Jan. 8, 2026

(54) SYSTEM AND METHOD FOR DATA INGESTION IN A NETWORK

(71) Applicant: JIO PLATFORMS LIMITED, Ahmedabad (IN)

(72) Inventors: Aayush BHATNAGAR, Navi Mumbai (IN); Uday Shankar SHANBHAG, Mulund, East Mumbai (IN); Rishi Raj KOUL, Delhi (IN); Virag PATEL, Nextown, Thane (IN); Sandeep BISHT, Kalyan Thane (IN); Lokesh POONIA, Rajasthan (IN); Pradeep Kumar BHATNAGAR, Navi Mumbai (IN)

(73) Assignee: JIO PLATFORMS LIMITED, Ahmedabad (IN)

(21) Appl. No.: 18/880,394

(22) PCT Filed: Apr. 12, 2024
(86) PCT No.: PCT/IN2024/050388

§ 371 Date: Dec. 31, 2024

(30) Foreign Application Priority Data
Apr. 29, 2023 (IN) 202321030871

(51) Int. Cl. H04W 24/02; H04W 28/26; H04W 72/51

(52) U.S. Cl. CPC H04W 24/02; H04W 28/26; H04W 72/51

(57) ABSTRACT

A method for data ingestion for utilization and consumption of data in network nodes is disclosed. The method includes receiving data associated with a network node, categorizing the received data based on one or more pre-defined data types, storing the categorized data in a database module (304). The method reserves at least one channel for the stored data. The at least one channel is reserved based on a pre-defined data type and a plurality of attributes associated with the network node. The method determines if there is a changed configuration data associated with the stored data at the network node. Responsive to determining that there is the changed configuration data, determining the at least one reserved channel for the changed configuration data based on the pre-defined data type and the plurality of attributes associated with the network node and pushing the changed configuration data over the determined reserved channel.

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to mechanisms for data ingestion, and specifically to a system and a method for ingesting and managing configuration data in a wireless network.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Typically, a wireless network comprises of a large number of network nodes, and their associated configuration data. Maintaining the network nodes and their configuration data requires a large storage space, and an equally quick and efficient data parsing logic for quick consumption of the configuration data to be presented to end users on layers and modules for their functioning. Currently available data ingestion mechanisms for managing huge volumes of the configuration data are inefficient and consume high volume of resources.

There is, therefore, a need in the art for an improved data ingestion mechanism for ingesting and managing the configuration data of the wireless network.

### OBJECTS OF THE PRESENT DISCLOSURE

It is an object of the present disclosure to ingest configuration data of a wireless network.

It is an object of the present disclosure to allow the breakage of huge volumes of ingested configuration data present in different categories and events and perform a channelization where each channel is reserved for obtaining a particular type of configuration data.

It is an object of the present disclosure to create channel reservation based on telecommunication circles as per the license provided by the Department of Telecommunications (DOT) (associated with the Government), with respect to a particular location, a particular geography and also with respect to any type of network node.

It is an object of the present disclosure to perform the channelization and break the ingested configuration data into pieces to monitor the channelized data individually.

It is an object of the present disclosure to restructure the configuration data to predetermined formats for easy and fast utilization.

It is an object of the present disclosure to extract meaningful insights from the ingested configuration data.

It is an object of the present disclosure to enhance a processing speed of the system to process the data, and thereby optimizing computational capacities.

It is an object of the present disclosure to manage the large amount of data of the network in near real time.

It is an object of the present disclosure to segregate the data based on one or more pre-defined rules.

It is an object of the present disclosure to optimize the network cost.

It is an object of the present disclosure to efficiently utilize the channel bandwidth.

It is an object of the present disclosure to efficiently utilize the processing power.

### SUMMARY

In an exemplary embodiment, the present invention discloses a method for data ingestion for utilization and consumption of data in network nodes. The method comprising receiving a data associated with a network node. The method comprising categorizing the received data based on one or more pre-defined data types. The method comprising storing the categorized data in a database module. The method comprising reserving at least one channel for the stored data. The at least one channel is reserved based on a pre-defined data type and a plurality of attributes associated with the network node. The method comprising determining if there is a changed configuration data associated with the stored data at the network node. When it is determined that there is the changed configuration data associated with the stored data, then performing the following steps: determining the at least one reserved channel for the changed configuration data based on the pre-defined data type and the plurality of attributes associated with the network node; and pushing, by the network node, the changed configuration data over the determined at least one reserved channel.

In some embodiments, the plurality of attributes includes at least one of a telecommunication circle associated with the network node, a particular location, a particular geography, or any type of network node.

In some embodiments, the telecommunication circle is identified by a Mobile Country Code (MCC) and a Mobile Network Code (MNC) associated with the network node.

In some embodiments, the changed configured data includes a selective data associated with the network node.

In some embodiments, the selective data is pushed as the changed configuration data in a parallel sequence manner by the network node.

In some embodiments, the data ingestion is performed in a real-time based on at least one report generated depending upon the changed configured data and the stored data.

In some embodiments, the method further comprising comparing a current configuration value of the changed configured data with a stored configuration value of the stored data.

In some embodiments, the method further comprising replacing the stored configuration value of the stored data with the current configuration value of the changed configured data.

In an exemplary embodiment, the present invention discloses a system for data ingestion in a network for utilization and consumption of data in network nodes. The system comprising a receiving module configured to receive a data associated with a network node. A data ingestion module connected to the receiving module and is configured to receive the data from the receiving module. The data ingestion module configured to categorize the received data based on one or more pre-defined data types. The data ingestion module configured to store the categorized data in a database module. The data ingestion module configured to reserve at least one channel for the stored data. The at least one channel is reserved based on a pre-defined data type and a plurality of attributes associated with the network node. The data ingestion module configured to determine if there is a changed configuration data associated with the stored data at the network node. When it is determined that there is the changed configuration data associated with the stored data, then the data ingestion module configured to performing the following steps determine the at least one reserved channel for the changed configuration data based on the pre-defined data type and the plurality of attributes associated with the network node; and push, by the network node, the changed configuration data over the determined at least one reserved channel.

In some embodiments, the plurality of attributes includes at least one of a telecommunication circle associated with the network node, a particular location, a particular geography, or any type of network node.

In some embodiments, the telecommunication circle is identified by a Mobile Country Code (MCC) and a Mobile Network Code (MNC) associated with the network node.

In some embodiments, the changed configured data includes a selective data associated with the network node.

In some embodiments, the selective data is pushed as the changed configuration data in a parallel sequence manner by the network node.

In some embodiments, the data ingestion is performed in a real-time based on at least one report generated depending upon the changed configured data and the stored data.

In some embodiments, the system is further configured to compare a current configuration value of the changed configured data with a stored configuration value of the stored data.

In some embodiments, the system is further configured to replace the stored configuration value of the stored data with the current configuration value of the changed configured data.

In an exemplary embodiment, the present invention discloses a network for data ingestion for utilization and consumption of data in network nodes. The network comprising a system comprising a receiving module configured to receive a data associated with a network node. A data ingestion module connected to the receiving module and is configured to receive the data from the receiving module. The data ingestion module configured to categorize the received data based on one or more pre-defined data types. The data ingestion module configured to store the categorized data in a database module. The data ingestion module configured to reserve at least one channel for the stored data. The at least one channel is reserved based on a pre-defined data type and a plurality of attributes associated with the network node. The data ingestion module configured to determine if there is a changed configuration data associated with the stored data at the network node. When it is determined that there is the changed configuration data associated with the stored data, then the data ingestion module configured to performing the following steps determine the at least one reserved channel for the changed configuration data based on the pre-defined data type and the plurality of attributes associated with the network node; and push, by the network node, the changed configuration data over the determined at least one reserved channel.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates a high-level system architecture of a wireless network with an Element Management System (EMS) and a Network Management Platform (NMP), in accordance with an embodiment of the present disclosure.

FIG. 2 illustrates a data ingestion module of the CP, in accordance with an embodiment of the present disclosure.

FIG. 3 illustrates a detailed block diagram representation of various exemplary modules of a data ingestion module, in accordance with an embodiment of the present disclosure.

FIG. 4 illustrates an exemplary computer system in which or with which embodiments of the present disclosure may be implemented.

FIG. 5 illustrates an exemplary flow diagram for a method for data ingestion for utilization and consumption of data in network nodes in accordance with an embodiment of the present disclosure.

### LIST OF REFERENCE NUMERALS

100—System architecture
102-1—gNodeB (gNB)
102-2, 102-3—Indoor small cell (IDSC)
104—Element management system (EMS)
106, 204—Network management platform (NMP)
108—Configuration management (CM) data ingestion module
110—CM module
112—Other module
114—Other non-module
116—Database
118—Network management platform users
120—User Equipment (UE)
200—Data ingestion module
202—Network Management System (NMS) event streaming platform clusters
300—Block Diagram
302—Channel determination module
304—Database module
306—Comparison module
308—Notifier module
310—Report generation module
400—A computer system
410—External storage device
420—Bus
430—Main memory
440—Read only memory
450—Mass storage device
460—Communication port(s)
470—Processor
500—Flow diagram

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Configuration Management (CM) is a critical function in a large telecom management sector, that helps a network team to provide an overview and analysis of node configuration data in a user presentable format, and also aids in configuring different network nodes through various submodules to provide a highly scalable, user friendly, and an optimal way to ensure fast deployment and smooth network operations. In order to achieve the effective deployment and smooth network operations, a configuration management system is required to have a configuration repository which is up to date with near real-time information from Fifth Generation (5G) network nodes, and it's associated Element Management Systems (EMS). The EMS manages functions and capabilities of specific types of one or more network elements within a telecommunication management network (TMN). The EMS communicates upward to higher-level systems of network management (NMS), in order to manage the traffic between itself and other network elements. The configuration repository is stored in an efficient manner which helps in effective utilization of space, and also provides data in an optimal manner for easy and quick consumption.

Sheer volume of the network nodes and its associated configuration information requires huge storage space, and a fast and efficient data parsing logic. The fast and efficient parsing logic is required for enabling optimal storage, and quick consumption of configuration data to be presented to an end user on NMP layers, and modules in their functioning. The NMS platform is used for end-to-end telecom network management. To meet this requirement, a dedicated CM data ingestion module is needed that has an effective and optimal design to ensure smooth operations during an entire life cycle for data ingestion.

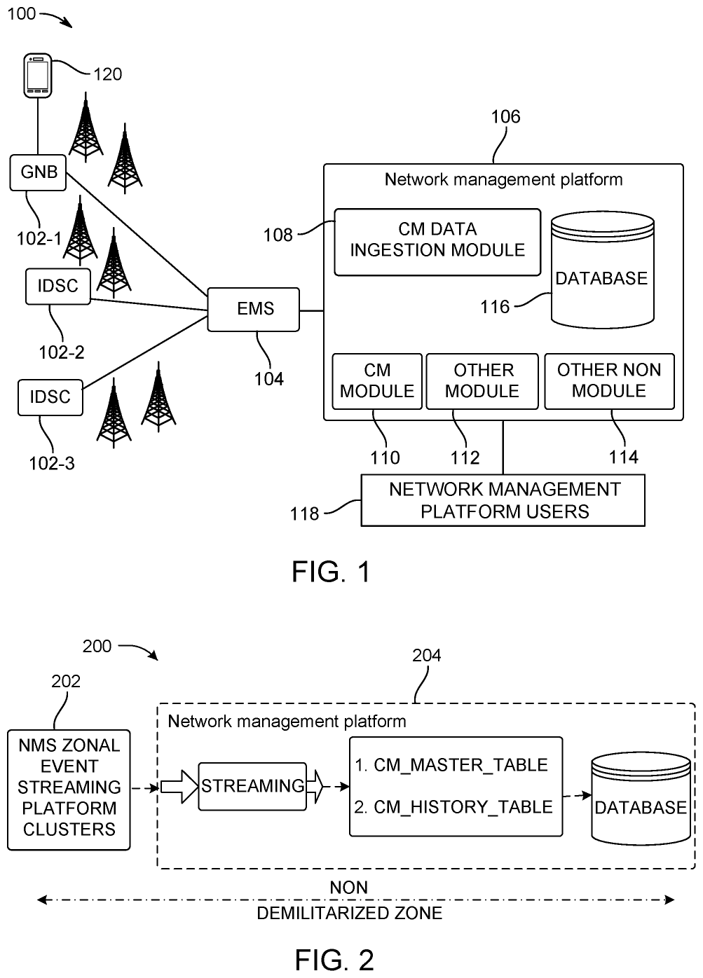

FIG. 1 illustrates a high-level system architecture (100) of a wireless network with the EMS and the CP, in accordance with an embodiment of the present disclosure. The high-level system architecture (100) includes a gNodeB (GNB) (102-1), indoor small cell (IDSC) (102-2, 102-3), element management system (EMS) (104), network management platform (NMP) (106), configuration management (CM) data ingestion module (108), CM module (110), other module (112), other non-module (114), database (116), network management platform users (118) and a user equipment (120). The disclosed configuration management system uses the CM data ingestion module (108) to remain updated in near real time, based on any change determined in the connected network nodes or the EMS (104) present in the network. To enable the configuration management system/module (110) to act in a timely manner, and to remain updated in near real time, selective data is pushed in a channelized manner. This enables the configuration management system to be effective and efficient in solving latency-related issues occurring during the data ingestion.

The CM data ingestion module (108) uses cloud-based services and microservices to break the node configuration data into different categories and events and perform channelization on the node configuration data (i.e., one channel is reserved for receiving the entire configuration data). This can be understood as, in an aspect, when the node configuration data is pushed from any node for any change occurring in the node, only the changed data may be at a specific instance pushed in a parallel sequence manner, based on predefined channels.

In an aspect, the predefined channels are reserved based on a pre-defined data type and a plurality of attributes associated with the network node. The plurality of attributes includes at least one of a telecommunication circle associated with the network node, a particular location, a particular geography, or any type of network node.

For a 5G product, the CM data ingestion module (108) uses this

mechanism to perform data management whenever there is a major change inside the node. For example, if the node takes a reboot, or if there is a software upgrade, or the like, the configuration management system (110) may push the entire configuration of that particular node at once. Also, if a user logs into the system and executes some changes, then the changes may be sent to the system via different channels.

It may be noted that the data in the configuration management system (110) is pushed at a particular milestone i.e., when a lot of configuration changes are determined in the system. All the configuration changes may be sent upon completion of the particular milestone so as to maintain a complete synchronization at both ends of the configuration management system. As may be appreciated, a minor set of the configuration changes may be sent intermittently. By way of an example, suppose there are 3000 parameters or 5000 parameters inside one of the nodes, and the user altered only one or two parameters of the node. In this case, the configuration changes are maintained with respect to only the altered one or two parameters of the node in terms of a previous parameter value and a new parameter value.

For effective execution of the CM data ingestion module (108), the configuration management system may break the network into multiple channels and may perform channel reservation based on one or more pre-defined rules for circle based segregation, such as based on a circle's code (i.e., every circle may have a Mobile Country Code (MCC)+Mobile Network Code (MNC)), which uniquely identifies the circle and performs data segregation based on the circle. For example, one or more channels may be reserved for a circle ‘A’ based on one or more pre-defined rules. In an embodiment, the one or more pre-defined rules are based on the parameter classification type and may be applied to any attribute of the parameter such as name, category, index etc. In an embodiment, the parameter type classification results in different channels for each such classification type per telecommunication circle associated with the network node, a particular location, a particular geography, or any type of network node. This may effectively organize the bulk changes at the node for optimized consumption at the receiving end to parse and store in the database (116).

Alternatively, the segregation may be done by one or more other pre-defined rules. Hence, instead of one particular channel bringing in every type of data, the channelization may be performed, where execution of the data ingestion module is segregated into pieces, and each of the modules is monitored individually. Upon witnessing any new demand requirement, additional resources may be added to the CM data ingestion module (108). This mechanism of breaking the network into multiple channels resolves the issue of processing large amounts of data in real-time. In an aspect, the CM data ingestion module (108) may be implemented in an apparatus (for example, the network management platform 106). In some examples, the apparatus may be a server device.

Further, the UE (120) may be communicatively coupled to the GNB (102-1) or IDSC (102-2 and/or 102-3). The coupling may be through a wireless network. In an exemplary embodiment, the wireless network may include, by way of example but not limitation, at least a portion of one or more networks having one or more nodes that transmit, receive, forward, generate, buffer, store, route, switch, process, or a combination thereof, etc., one or more messages, packets, signals, waves, voltage or current levels, some combination thereof, or so forth. The UE (120) can be any handheld device, mobile device, palmtop, laptop, smart phone, pager and the like. As a result of the coupling, the UE (120) may be configured to receive a connection request from the GNB (102-2), send an acknowledgment of connection request to the GNB (102-2) and further transmit a plurality of signals in response to the connection request.

FIG. 2 illustrates the data ingestion module (200) of the NMP, in accordance with an embodiment of the present disclosure. The data ingestion module 200 refers to the CM data ingestion module 108 shown in FIG. 1. In an aspect, the data ingestion module (200) includes NMS event streaming platform clusters and an NMS (204).

As is illustrated, streaming jobs consume all events directly from corresponding zonal event streaming platform's (for example, Network Management System (NMS)) topic and tag. Required fields like circle and configuration details are available in a database table. The data is written into a distributed column-oriented database and in history tables.

Description of the distributed column-oriented database is as follows:
By way of an example, there may be two tables which may have a capacity to serve most use cases.
   1. CM_Master_Table
   2. CM_History_Table

### The CM_Master_Table

This table may maintain running CM parameter values of all sites. For this table, a computation action (i.e., a spark job) may work as “Upsert” for a specific row key design i.e., if the record exists in this table for a specific site, then new parameters may be updated against existing row key, else if the row key does not exist for a new site record, then that record may be inserted in the CM_Master_Table.

ROW-KEY design for the CM_Master_Table: Row key contains a combination of circle+configuration details+Site_ID. The CM_Master_Table may contain a total record that equals the total number of sites obtained from the event streaming platform's topic. It enables fetching/getting the latest running CM parameter values for any site available in the configuration platform.

The CM_History_Table: This is another table created in the database to maintain a history of all the transactions obtained from the event streaming platform. The computation action may work as “insert” only for each new row-key i.e., for each record for a site that is consumed from the event streaming platform's topic, the record is inserted into the database table, leading to a new record being created in the table for each transaction.

ROW-KEY design for the CM_History_Table: Row key may contain a combination of circle+configuration details+Site_ID+Timestamp. The CM_History_Table may contain all the records consumed from the event streaming platform's topic for a certain period of days i.e., as per business requirements.

As may be appreciated, retention policy on the CM_History_Table is equal to a number of days of historical data required by a business team.

The CM_History_Table facilitates to maintain use cases like latest and previous record values of the CM parameters for any site available in the computation platform.

In an embodiment, there is disclosed a parameter parsing and a parameter

value database. The NMP may receive a full configuration or one or multiple parameters in data formats (e.g., as a JavaScript Object Notation (JSON) from the EMS present in corresponding virtual groups or logs.

Exemplary, the parameters are classified in two major types:
1. Scalar parameters: These are the type of parameters that do not have indices.
2. Tabular parameters: These are the type of parameters that contain indices.
   The NMP may retrieve these parameters and store the information in NMP tables.

In an embodiment, for databases used to store configuration records (for example, Configuration Management Database (CMDB)), the NMP may only process small cell's (for example, Outdoor Small Cell (ODSC)) node type and create two tables:
1. Current Config Table: This table may contain all the parameter categories i.e., parameter names and indices (if applicable), and store a parameter value against each unique combination of (parameter type+parameter category+parameter name+index) for each of the ODSC in the network. It may be noted that indices of all the different nodes (i.e., of the ODSC) may differ in terms of actual number as well as total count of indices, even if they belong to the same software version. The differences in the count of the indices may be captured, stored, and presented to an end user accurately in any form, for example, as excel reports, User Interface (UI), different modules using Application Programming Interfaces (APIs) etc., when requested.
2. Change History Table: This table may maintain all changes determined in the parameter value for a corresponding Service Access Point (SAP) Identifier (ID) of a node against each unique parameter (Parameter Type+Parameter Category+Parameter Name+Index (if applicable)), along with a change of value, other details like, date and time of the change, source of change (for example, NMP work order ID), and may be stored and presented to the end user or other NMP modules when requested.

As may be appreciated, the changed parameter may be received in any form of the EMS, i.e., either in full configuration after reboot, or single parameter, or bulk parameter in the corresponding virtual groups of the EMS. In an embodiment, the changes may be stored for a period of 90 days after which old data may be purged automatically.

Parameter Category Exclusion: The NMP may maintain a configuration file which may contain parameter categories that are needed to be excluded from parsing, storing, and reporting. For example, if the NMP exclude configuration file contains a parameter category CU_CELLVS_NRCELL, then the NMP may ignore all parameter names which start with “CU_CELLVS_NRCELL” in their category name i.e.,
CU_CELLVS_NRCELL
CU_CELLVS_NRCELL_MODE_FDD
CU_CELLVS_NRCELL_MODE_FDD_NRDL_NUMFREQBANDS
CU_CELLVS_NRCELL_MODE_FDD_NRUL_NUMFREQBANDS
CU_CELLVS_NRCELL_MODE_TDD
CU_CELLVS_NRCELL_MODE_TDD_NUMFREQBANDS
   Else, all the parameters received from the EMS may be parsed, stored, and presented.

Parameter Dictionary: Every parameter in the configuration file, per software release may have a dictionary file which defines parameter's default range, minimum and maximum range, data type, a determining factor to determine if the parameter is a service impacting parameter, and the like. This information is also made available in an object notion type (for example, config Json).

The NMP may keep a separate dictionary for every software release for each node type. This dictionary may be used by other modules in the CM, or for golden audits, etc. The NMP may create this dictionary automatically using the object notion type received, which contains an entire configuration of a particular node type from the EMS for any new release encountered on CM_FULL_INIT_CONFIG virtual group.

The NMP may parse a s structured data type received in CM_FULL_INIT_CONFIG and compare values with existing configuration in the NMP table for any changes. If there are any changes, the NMP may store the changes in the change history table and replace the current config in the current config table. However, if a software version change is determined, the NMP may check for availability of reported software version dictionary in the CP. If a new software version is encountered, the NMP may create a new dictionary for similar listing of all parameters category, parameter name, and its properties i.e., its range, default value, data type, etc. i.e., all information available in the structured data type (for example, JSON).

In an embodiment, the present disclosure enables creation of reports. Two different types of reports may be created:
1. Radio Access Network (RAN) node configuration report
2. RAN configuration change history report
   The RAN node configuration report may contain an entire configuration of selected nodes, for example, OSDC RAN configuration, other node samples, and the like. The RAN configuration change history report may contain the entire configuration changes of the selected nodes between a date range selected by the user, for example, up to a maximum of 90 days.

In an exemplary embodiment, features and requirements of a 5G CM data ingestion module (200) is discussed. The 5G CM data ingestion module (200) may support a cloud architecture, and may use industry latest technologies based on a micro service architecture to meet below mentioned requirements:
1. 5G CM may be a replica of master EMS with an entire up to date configuration dump of all RAN nodes in the 5G network.
2. For optimal functioning, only incremental changes may be offered to the 5G CM data ingestion module (200) on a near real time basis, i.e., in and around 5 sec time intervals from change on actual nodes.
3. Each integration may be designed in accordance with security norms as laid down by an information security team.
4. Enough redundancy for each link may be considered, such that configuration of all the nodes is always available and the NMP system is capable of handling up to 50K config changes in any instance, and up to 5 million changes per day in near real time.
5. In an odd case, where the link between the NMP and the EMS is down for some time, changes happening in the network controlled by the EMS may be available for the NMP to collect when connectivity is restored.
6. Design of the data ingestion module (200) may consider hardware failures at card level, hard disk, server level, link layer, etc., while ensuring 99.9% uptime.
7. Data ingested may be stored in an optimal manner such that it consumes optimal space.
8. The generated reports may be made available to the end user within 2 minutes of raising a request.
9. The configuration change information may be available for up to 90 days.

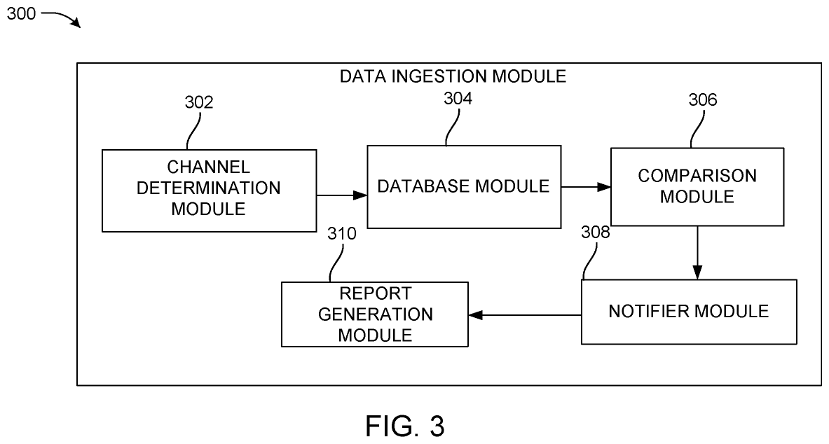

FIG. 3 illustrates a detailed block diagram representation 300 of various exemplary modules of the data ingestion module (200), according to embodiments of the present disclosure. The block diagram (300) of the data ingestion module (200) includes a channel determination module (302), database module (304), comparison module (306), notifier module (308), and report generation module (310). With respect to FIG. 3, the channel determination module (302) determines a particular channel for transfer of the node configuration data. For any change occurring in the node, only the changed data at a specific instance is pushed in a parallel sequence manner, based on the pre-defined channels.

In an aspect the predefined channels are reserved based on a pre-defined data type and a plurality of attributes associated with the network node. The plurality of attributes includes at least one of a telecommunication circle associated with the network node, a particular location, a particular geography, or any type of network node.

Further, the database module (304) is provided for storing the configuration data. The configuration data is stored in a column-oriented database and maintained in either of the master table or the history table. In addition, there is provided a comparison module (306) for comparing the configuration data. The NMP may parse a received structured data structure and compare values with existing configuration in the NMP table for any changes. If any changes are determined, the NMP may store the changes in the change history table. Also, the current configuration in the current configuration table is replaced.

Further, a notifier module (308) notifies the changes made in the pushed data. For any change occurring in the node, the node configuration data is pushed from the node in a parallel sequence manner, based on the predefined channel reservations.

In addition, there is provided a report generation module (310) for creation of the reports. By way of an example, one report may be the RAN node configuration report, and the other may be the RAN configuration change history report. The RAN node configuration report may contain an entire configuration of selected nodes, for example, OSDC RAN configuration, other node samples, and the like. The RAN configuration change history report may contain the entire configuration changes of the selected nodes between a date range selected by the user, for example, up to a maximum of 90 days.

The disclosed CM data ingestion module (200) is designed and developed to address the problem of providing and maintaining a large number of network nodes, and its associated configuration information. The module provides huge storage space, an equally quick and efficient data parsing logic for optimal storage, and quick consumption of the configuration data to be presented to the end user on the NMP Layers, other NMP modules, and external non-NMP modules for their functioning.

The information for different 5G RAN nodes like gNB, Indoor Small Cell (IDSC), and ODSC, and others captured from the EMS may be collected on a daily basis and presented to the end user for routine daily operational management. The information may also be used by the different CMs and the other NMP modules to perform an end-to-end functionality, and also give an overview of the entire network as a snapshot so as to be able to easily scale to perform critical functions like auditing that are present in 4G CM.

In an exemplary embodiment, the present invention discloses a method for data ingestion for utilization and consumption of data in network nodes. The method comprising receiving a data associated with a network node. The method comprising categorizing the received data based on one or more pre-defined data types. The method comprising storing the categorized data in a database module. The method comprising reserving at least one channel for the stored data. The at least one channel is reserved based on a pre-defined data type and a plurality of attributes associated with the network node. The method comprising determining if there is a changed configuration data associated with the stored data at the network node. When it is determined that there is the changed configuration data associated with the stored data, then performing the following steps: determining the at least one reserved channel for the changed configuration data based on the pre-defined data type and the plurality of attributes associated with the network node; and pushing, by the network node, the changed configuration data over the determined at least one reserved channel.

In some embodiments, the plurality of attributes includes at least one of a telecommunication circle associated with the network node, a particular location, a particular geography, or any type of network node.

In some embodiments, the telecommunication circle is identified by a Mobile Country Code (MCC) and a Mobile Network Code (MNC) associated with the network node.

In some embodiments, the changed configured data includes a selective data associated with the network node.

In some embodiments, the selective data is pushed as the changed configuration data in a parallel sequence manner by the network node.

In some embodiments, the data ingestion is performed in a real-time based on at least one report generated depending upon the changed configured data and the stored data.

In some embodiments, the method further comprising comparing a current configuration value of the changed configured data with a stored configuration value of the stored data.

In some embodiments, the method further comprising replacing the stored configuration value of the stored data with the current configuration value of the changed configured data.

In an exemplary embodiment, the present invention discloses a system for data ingestion in a network for utilization and consumption of data in network nodes. The system comprising a receiving module configured to receive a data associated with a network node. A data ingestion module connected to the receiving module and is configured to receive the data from the receiving module. The data ingestion module configured to categorize the received data based on one or more pre-defined data types. The data ingestion module configured to store the categorized data in a database module. The data ingestion module configured to reserve at least one channel for the stored data. The at least one channel is reserved based on a pre-defined data type and a plurality of attributes associated with the network node. The data ingestion module configured to determine if there is a changed configuration data associated with the stored data at the network node. When it is determined that there is the changed configuration data associated with the stored data, then the data ingestion module configured to performing the following steps determine the at least one reserved channel for the changed configuration data based on the pre-defined data type and the plurality of attributes associated with the network node; and push, by the network node, the changed configuration data over the determined at least one reserved channel.

In some embodiments, the plurality of attributes includes at least one of a telecommunication circle associated with the network node, a particular location, a particular geography, or any type of network node.

In some embodiments, the telecommunication circle is identified by a Mobile Country Code (MCC) and a Mobile Network Code (MNC) associated with the network node.

In some embodiments, the changed configured data includes a selective data associated with the network node.

In some embodiments, the selective data is pushed as the changed configuration data in a parallel sequence manner by the network node.

In some embodiments, the data ingestion is performed in a real-time based on at least one report generated depending upon the changed configured data and the stored data.

In some embodiments, the system is further configured to compare a current configuration value of the changed configured data with a stored configuration value of the stored data.

In some embodiments, the system is further configured to replace the stored configuration value of the stored data with the current configuration value of the changed configured data.

In an exemplary embodiment, the present invention discloses a network for data ingestion for utilization and consumption of data in network nodes. The network comprising a system comprising a receiving module configured to receive a data associated with a network node. A data ingestion module connected to the receiving module and is configured to receive the data from the receiving module. The data ingestion module configured to categorize the received data based on one or more pre-defined data types. The data ingestion module configured to store the categorized data in a database module. The data ingestion module configured to reserve at least one channel for the stored data. The at least one channel is reserved based on a pre-defined data type and a plurality of attributes associated with the network node. The data ingestion module configured to determine if there is a changed configuration data associated with the stored data at the network node. When it is determined that there is the changed configuration data associated with the stored data, then the data ingestion module configured to performing the following steps determine the at least one reserved channel for the changed configuration data based on the pre-defined data type and the plurality of attributes associated with the network node; and push, by the network node, the changed configuration data over the determined at least one reserved channel.

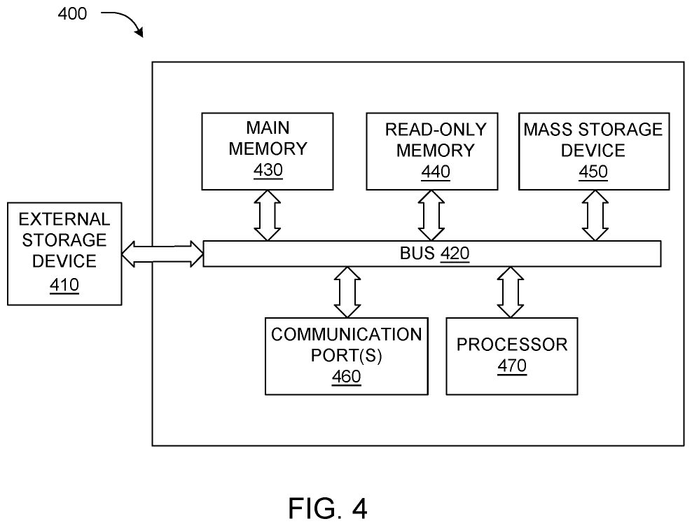

FIG. 4 illustrates an exemplary computer system 400 in which or with which embodiments of the present disclosure may be implemented. As shown in FIG. 4, the computer system 400 may include an external storage device 410, a bus 420, a main memory 430, a read-only memory 440, a mass storage device 450, communication port(s) 460, and a processor 470. A person skilled in the art will appreciate that the computer system 400 may include more than one processor and communication ports. The processor 470 may include various modules associated with embodiments of the present disclosure. The communication port(s) 460 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 460 may be chosen depending on a network, such a Local Area Network (LAN), Wide Area Network (WAN), or any network to which the computer system 400 connects.

The main memory 430 may be random access memory (RAM), or any other dynamic storage device commonly known in the art. The read-only memory 440 may be any static storage device(s) e.g., but not limited to, a Programmable Read Only Memory (PROM) chips for storing static information e.g., start-up or Basic Input/Output System (BIOS) instructions for the processor 470. The mass storage device 450 may be any current or future mass storage solution, which can be used to store information and/or instructions. Exemplary mass storage device 450 includes, but is not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks.

The bus 420 communicatively couples the processor 470 with the other memory, storage, and communication blocks. The bus 420 may be, e.g. a Peripheral Component Interconnect (PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor 470 to the computer system 400.

Optionally, operator and administrative interfaces, e.g., a display, keyboard, joystick, and a cursor control device, may also be coupled to the bus 420 to support direct operator interaction with the computer system 400. Other operator and administrative interfaces can be provided through network connections connected through the communication port(s) 460. Components described above are meant only to exemplify various possibilities. In no way should the aforementioned exemplary computer system 400 limit the scope of the present disclosure.

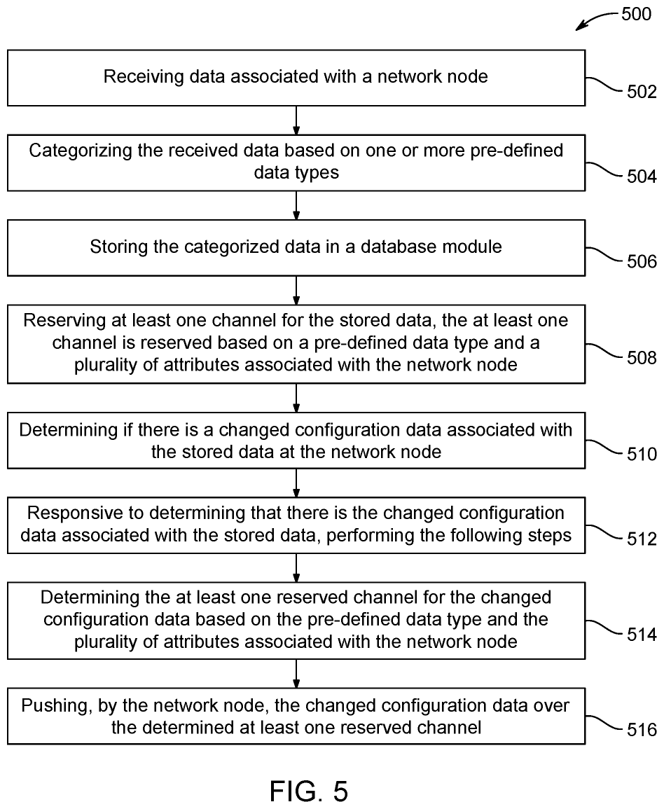

FIG. 5 illustrates an exemplary flow diagram for a method for data ingestion for utilization and consumption of data in network nodes in accordance with an embodiment of the present disclosure.

At step 502, the method comprising receiving data associated with a network node.

At step 504, the method comprising categorizing the received data based on one or more pre-defined data types.

At step 506, the method comprising storing the categorized data in a database module.

At step 508, the method comprising reserving at least one channel for the stored data. The at least one channel is reserved based on a pre-defined data type and a plurality of attributes associated with the network node.

At step 510, the method comprising determining if there is a changed configuration data associated with the stored data at the network node.

At step 512, the method comprising responsive to determining that there is the changed configuration data associated with the stored data, performing the step 514 and step 516 respectively.

At step 514, the method comprising determining the at least one reserved channel for the changed configuration data based on the pre-defined data type and the plurality of attributes associated with the network node.

At step 516, the method comprising pushing, by the network node, the changed configuration data over the determined at least one reserved channel.

In an aspect, the proposed system and method to ingest configuration data is configured to be employed in a 5G telecommunication network. The proposed system and method allow breakage of huge volumes of the ingested configuration data present in different categories and events and performs a channelization where each channel is reserved for obtaining a particular type of the configuration data. Thus, the proposed system and method facilitates extract meaningful insights from the ingested data and provides enhance processing speed of the system to process the data and thereby optimizing the computational capacities.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure facilitates to ingest configuration data of a wireless network.

The present disclosure allows breakage of huge volumes of the ingested configuration data present in different categories and events and performs a channelization where each channel is reserved for obtaining a particular type of the configuration data.

The present disclosure creates channel reservation based on circles.

The present disclosure performs the channelization and breaks the ingested configuration data into pieces so as to individually monitor the channelized data.

The present disclosure facilitates to restructure the configuration data to predetermined formats for easy and fast utilization.

The present disclosure enables to extract meaningful insights from the ingested data.

The present disclosure facilitates to enhance processing speed of the system to process the data, and thereby optimizing the computational capacities.

The present disclosure facilitates to manage the large amount of data of the network in near real time.

The present disclosure facilitates to segregate the data based on one or more pre-defined rules.

The present disclosure facilitates to optimize the network cost.

We claim:

1. A method for data ingestion for utilization and consumption of data in network nodes, the method comprising:
receiving data associated with a network node;
categorizing the received data based on one or more pre-defined data types;
storing the categorized data in a database module (304);
reserving at least one channel for the stored data, wherein the at least one channel is reserved based on a pre-defined data type and a plurality of attributes associated with the network node;
determining if there is a changed configuration data associated with the stored data at the network node;
responsive to determining that there is the changed configuration data associated with the stored data, performing the following steps:
determining the at least one reserved channel for the changed configuration data based on the pre-defined data type and the plurality of attributes associated with the network node; and
pushing, by the network node, the changed configuration data over the determined at least one reserved channel.

2. The method as claimed in claim 1, wherein the plurality of attributes includes at least one of a telecommunication circle associated with the network node, a particular location, a particular geography, or any type of network node.

3. The method as claimed in claim 2, wherein the telecommunication circle is identified by a Mobile Country Code (MCC) and a Mobile Network Code (MNC) associated with the network node.

4. The method as claimed in claim 1, wherein the changed configured data comprises a selective data associated with the network node.

5. The method as claimed in claim 1, wherein the selective data is pushed as the changed configuration data in a parallel sequence manner by the network node.

6. The method as claimed in claim 1, wherein the data ingestion is performed in a real-time by a data ingestion module (200) based on at least one report generated depending upon the changed configured data and the stored data.

7. The method as claimed in claim 1, further comprising comparing a current configuration value of the changed configured data with a stored configuration value of the stored data.

8. The method as claimed in claim 7, further comprising replacing the stored configuration value of the stored data with the current configuration value of the changed configured data.

9. A system for data ingestion in a network for utilization and consumption of data in network nodes, the system comprising:
a receiving module configured to:
receive data associated with a network node;
a data ingestion module (200) connected to the receiving module and is configured to:
receive the data from the receiving module;
categorize the received data based on one or more pre-defined data types;
store the categorized data in a database module (304);
reserve at least one channel for the stored data; wherein the at least one channel is reserved based on a pre-defined data type and a plurality of attributes associated with the network node;
determine if there is a changed configuration data associated with the stored data at the network node;
responsive to determining that there is the changed configuration data associated with the stored data, perform the following steps:
determine the at least one reserved channel for the changed configuration data based on the pre-defined data type and the plurality of attributes associated with the network node; and
push, by the network node, the changed configuration data over the determined at least one reserved channel.

10. The system as claimed in claim 9, wherein the plurality of attributes includes at least one of a telecommunication circle associated with the network node, a particular location, a particular geography, or any type of network node.

11. The system as claimed in claim 10, wherein the telecommunication circle is identified by a Mobile Country Code (MCC) and a Mobile Network Code (MNC) associated with the network node.

12. The system as claimed in claim 9, wherein the changed configured data includes a selective data associated with the network node.

13. The system as claimed in claim 9, wherein the selective data is pushed as the changed configuration data in a parallel sequence manner by the network node.

14. The system as claimed in claim 9, wherein the data ingestion module processes data in a real-time based on at least one report generated depending upon the changed configured data and the stored data.

15. The system as claimed in claim 9, further configured to compare a current configuration value of the changed configured data with a stored configuration value of the stored data.

16. The system as claimed in claim 15, further configured to replace the stored configuration value of the stored data with the current configuration value of the changed configured data.

17. A network for data ingestion for utilization and consumption of data in network nodes, the network comprising a system comprising:
a receiving module configured to:
receive data associated with a network node;
a data ingestion module (200) connected to the receiving module and is configured to:
receive the data from the receiving module;
categorize the received data based on one or more pre-defined data types;
store the categorized data in a database module (304);
reserve at least one channel for the stored data, wherein the at least one channel is reserved based on a pre-defined data type and a plurality of attributes associated with the network node;
determine if there is a changed configuration data associated with the stored data at the network node;
responsive to determining that there is the changed configuration data associated with the stored data, perform the following steps:
determine the at least one reserved channel for the changed configuration data based on the pre-defined data type and the plurality of attributes associated with the network node; and
push, by the network node, the changed configuration data over the determined at least one reserved channel.

18. A computer program product comprising a non-transitory computer-readable medium comprising instructions that, when executed by one or more processors, cause the one or more processors to perform a method for network slicing in a network, the method comprising:
receiving a data associated with a network node;
categorizing the received data based on one or more pre-defined data types;
storing the categorized data in a database module (304);
reserving at least one channel for the stored data, wherein the at least one channel is reserved based on a pre-defined data type and a plurality of attributes associated with the network node;
determining if there is a changed configuration data associated with the stored data at the network node;
responsive to determining that there is the changed configuration data associated with the stored data, performing the following steps:
determining the at least one reserved channel for the changed configuration data based on the pre-defined data type and the plurality of attributes associated with the network node; and
pushing, by the network node, the changed configuration data over the determined at least one reserved channel.

19. An apparatus comprising a data ingestion module (108, 200) as claimed in claim 9.

20. A user equipment (UE) (120) communicatively coupled with a network, said coupling comprises steps of:
receiving, by the network, a connection request;
sending an acknowledgment of the connection request to the UE (120);
transmitting a plurality of signals in response to the connection
request, wherein said network comprising a data ingestion module (108, 200) as claimed in claim 17.
